(19) United States
(12) Patent Application Publication
(10) Pub. No.: US 2023/0394403 A1
(43) Pub. Date: Dec. 7, 2023

(54) SUSTAINABILITY PLANNER FOR REGULATED INDUSTRIES

(71) Applicant: Vertex, Inc., King of Prussia, PA (US)

(72) Inventors: Chris Zangrilli, Trappe, PA (US); Kathryn E. Hughes, London (GB); Jack Towler, Liverpool (GB); Christopher T. Bottorf, Boston, MA (US)

(21) Appl. No.: 18/327,793

(22) Filed: Jun. 1, 2023

Related U.S. Application Data
(60) Provisional application No. 63/365,823, filed on Jun. 3, 2022.

(51) Int. Cl. G06Q 10/0631

(52) U.S. Cl. CPC G06Q 10/06313

(57) ABSTRACT

A sustainability planner may include a server computing device. The server computing device may be configured to ingest legislation data to generate a legislation model including legislation rules of a legislation, using an AI modeling engine. The server computing device may be configured to receive client data of an organization including covered by the legislation. The server computing device may be configured to apply the parameters of the client data to the legislation model to calculate a financial impact of the legislation on the organization. The server computing device may be configured to calculate a sustainability impact metric indicating an overall impact of a plurality of legislation including the legislation and other legislation on the organization, based at least on the financial impact of the legislation. The server computing device may be configured to send the financial impact and the sustainability impact metric to a client device.

### CROSS REFERENCE TO RELATED APPLICATIONS

This application claims priority to U.S. Provisional Patent Application No. 63/365,823, filed Jun. 3, 2022, the entirety of which is hereby incorporated herein by reference for all purposes.

### BACKGROUND

As our understanding of human impact on the environment develops, many organizations aim to improve their sustainability and reduce negative environmental impact. To encourage these improvements, many governments are implementing new legislation that govern various activities such as plastics recycling and disposal. The new legislation often includes various fees or taxes related to specific activities, along with penalties or incentives. It can be difficult for an organization to understand the effect new legislation will have on them, or even what the legislation entails. This problem is compounded by the fact that legislation may be enacted at various levels of government, in each town, region, and country, throughout the world, and may be frequently updated as the pace of legislative activity quickens.

### SUMMARY

A sustainability planner is provided herein, which may include a server computing device including one or more processors configured to execute instructions stored in associated memory to perform various functions. The server computing device may be configured to receive client data of an organization including covered by the legislation. The server computing device may be configured to apply the parameters of the client data to the legislation model to calculate a financial impact of the legislation on the organization. The server computing device may be configured to calculate a sustainability impact metric indicating an overall impact of a plurality of legislation including the legislation and other legislation on the organization, based at least on the financial impact of the legislation. The server computing device may be configured to send the financial impact and the sustainability impact metric to a client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example sustainability planner.

FIG. 2 shows an example flowchart of a method for estimating a financial impact and sustainability impact metric performed by the sustainability planner of FIG. 1.

FIG. 3 shows an example of client data input to the sustainability planner of FIG. 1.

FIG. 4 shows an example of detailed substeps of a step of the flowchart of FIG. 2.

FIG. 5 shows an example of the financial impact calculated by the sustainability planner of FIG. 1.

FIG. 6 shows a chart breaking down an example of the sustainability impact metric calculated by the sustainability planner of FIG. 1.

FIG. 7 shows a schematic view of an example computing environment in which the sustainability planner of FIG. 1 may be enacted.

### DETAILED DESCRIPTION

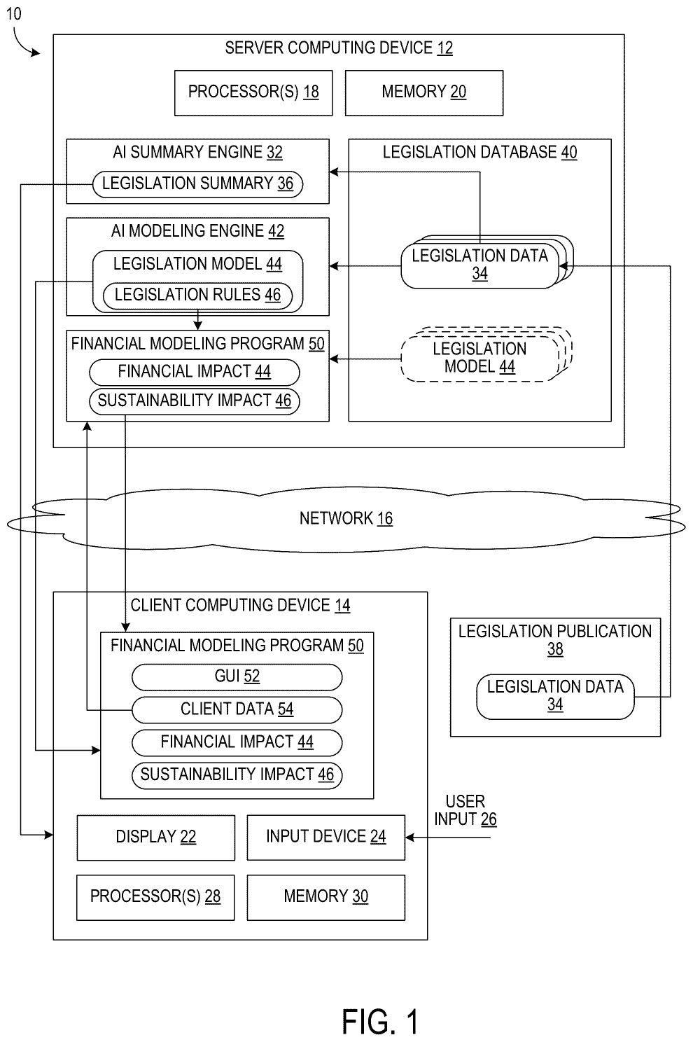

To address the above issues, FIG. 1 shows a schematic view of an example sustainability planner 10. The sustainability planner 10 may include a server computing device 12 configured to communicate with a client computing device 14 over a network 16 (e.g., the internet). The server computing device 12 may include one or more processors 18 configured to execute instructions stored in memory 20 to perform various functions. The client computing device 14 may include a display 22 configured to present information to the user, an input device 24 configured to receive user input 26 from the user, and one or more processor 28 configured to execute instructions stored in memory 30 to perform various functions. The instructions of the server computing device 12 may include various engines and programs, for example, an AI summary engine 32 which is configured to ingest legislation data 34 and generate a summary 36 of the legislation data 34 for easy consumption by a user of the client computing device 14. The legislation data 34 may be the text of a law or regulation that is, for example, published in a legislation publication repository accessible to the public. Most government entities enacting legislation make the text of new legislation freely available online, and the server computing device 12 may be configured to automatically scan known sources of legislation publications 38 for updates via the internet and retrieve the legislation data 34 for ingesting. The AI summary engine 32 may be trained on other legislation data 34 through machine learning so that at runtime, the AI summary engine 32 may be able to generate aspects of the legislation summary 36 including, for example, the topic of the legislation, what items or activities are being taxed or otherwise regulated, a jurisdiction to which the legislation applies, fees and penalties imposed, due dates and timelines, exemptions allowed, and definitions of relevant terms as used in the legislation.

The server computing device 12 may further include a legislation database 40 for storing the legislation data 34. The legislation database 40 may be configured to store legislation data 34 corresponding to many different laws. Multiple laws may be relevant to a single user of the client computing device 14, and a plurality of users in different regulated industries may operate a plurality of client computing devices 14. The server computing device 12 may further include an AI modeling engine 42 configured to ingest the legislation data 34 to generate a legislation model 44 including legislation rules 46 using machine learning. Alternatively or additionally, the legislation model 44 may be generated by a human coding the legislation model 44. The generated legislation model 44 may be stored with a plurality of legislation models 44 corresponding to different legislation in the legislation database 40, for use by the same or a different user. The legislation model 44 may be a mathematical model or computer code representing the content of the legislation. Briefly, the server computing device 12 may be configured to generate a financial impact 46 of the legislation, as well as a sustainability impact metric 48, which will be described in further detail below.

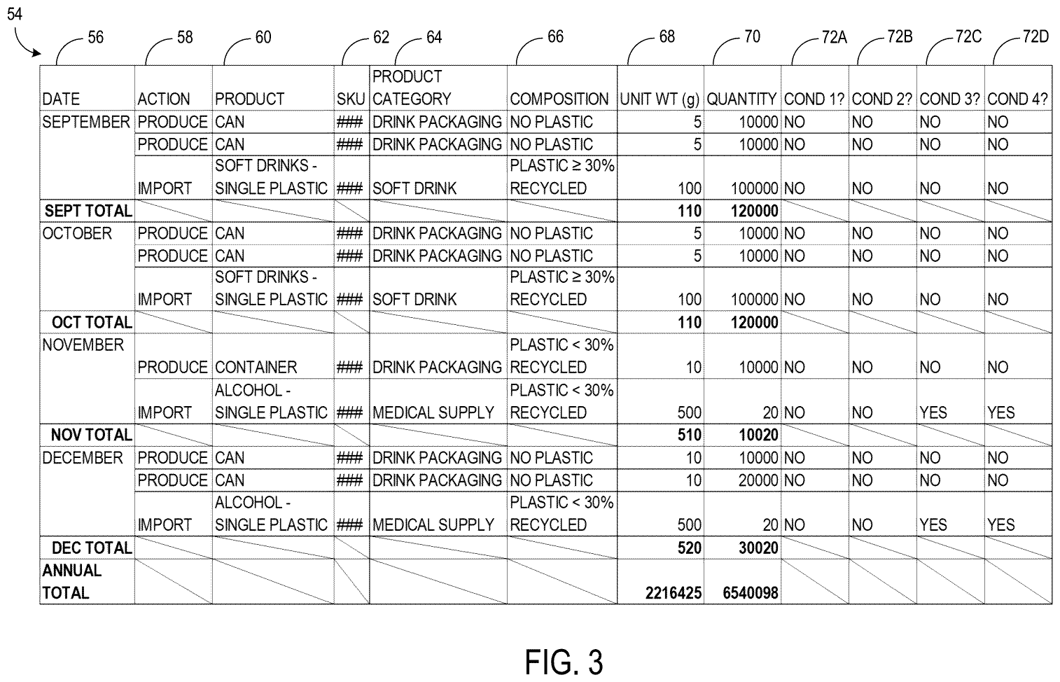

A financial modeling program 50 may be operated on the server side, client side, or distributed between the two. The financial modeling program 50 on the client side may be a dedicated application program executable to present a graphical user interface (GUI) 52 on the display 22, or an internet browser configured to connect to a website hosted by the server computing device 12 or by another server that has received data from the server computing device 12. The user may input client data 54, which may be entered manually via user input or typical financial documents such as inventory lists, receipts, and invoices that are scanned with keyword searches for an algorithm to determine relevant client data for the financial modeling program. The client data 54 may include parameters such as quantity, weight, and categories of products and/or materials covered by the legislation, as will be discussed in more detail below with reference to FIG. 3.

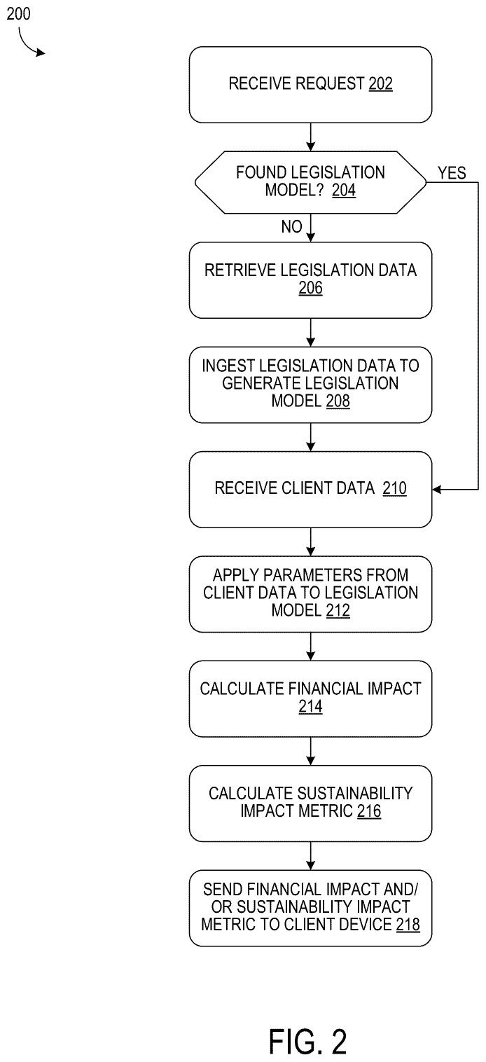

FIG. 2 shows an example flowchart of a method 200 for estimating a financial impact performed by the sustainability planner of FIG. 1. It will be appreciated that the method may be performed by other suitable equipment, and the illustrated steps may be performed in a different order than presented, omitted, or replaced. The method may begin by the financial modeling program 50, either on the client computing device 14 or the server computing device 12, at 202, receiving a request from the client computing device 14 to produce a financial impact 44. For example, the GUI 52 may display a selectable element offering to estimate the financial impact 44 of a new law on an organization to which the user belongs, such as a company.

Once the request is received, the financial modeling program 50 is configured to, at 204, determine whether or not a suitable legislation model 44 is available in the legislation database 40 or in the memory 30 of the client computing device 14. If NO, then the AI modeling engine 42 may first retrieve the legislation data 34 from the legislation database 40 at 206, and ingest the legislation data 34 to generate the legislation model 44 with the legislation rules from the legislation data at 208, as discussed above. If YES, then the server computing device 12 may receive the client data 54 of the organization from the client computing device 14, or the financial modeling program 50 on the client computing device 14 may retrieve the client data 54 from the memory 30 or receive the client data 54 from user input, at 210. Once the legislation model 44 and the client data 54 are both obtained, the financial modeling program 50 may be configured to apply the parameters of the client data 54 to the legislation model 44, at 212, to calculate a financial impact 44 of the legislation on the organization, at 214. Further, at 216, the financial modeling program 50 may be configured to calculate a sustainability impact metric 46 indicating an overall impact of a plurality of legislation including the legislation and other legislation on the organization, based at least on the financial impact 44 of the legislation calculated at 214. Finally, at 218, the financial modeling program 50 may be configured to present the financial impact 44 and/or the sustainability impact metric 46 to the client computing device 14, for example, by displaying the financial impact 44 on the display 22 or delivering a file including the financial impact 44. An example of each of the financial impact 44 and the sustainability impact metric 46 will be discussed in detail below.

First, an example of the client data 54 according to one implementation is shown in FIG. 3 in spreadsheet form. However, it will be appreciated that the client data 54 may take any suitable form that is usable by a program to perform calculations. Furthermore, the client data 54 may include additional or different parameters and data than illustrated in FIG. 3, depending on what legislation is being modeled and what goals the organization has expressed interest in tracking. The client data 54 in FIG. 3 may be collected in response to new legislation regarding plastic content in product packaging. A date column 56 may list the date or month of each entry. Here, only four months are illustrated for brevity. An action column 58 may list the regulated action taken by the organization; here, the example actions are “produce” or “import.” That is, the organization either produced or imported the product packaged in the packaging. The action is relevant because the legislation may regulate the packaging differently depending on the action taken. For example, packaging on imported products may be exempt or taxed at a different rate than packaging on a product produced by the organization.

A product column 60 may list a description of the imported or produced product, and a SKU column 62 may list an associated stock keeping unit. A product category column 64 may list the associated product category of each product, which may be treated differently under the legislation. For example, medical supplies may be exempt from the tax. A composition column 66 may list the material content of each type of material in the packaging. For example, plastic packaging that is 30% or more recycled may be exempt from the tax, while further rules in the legislation model may determine how to categorize and tax more complicated cases such as composite materials. A unit weight column 68 and quantity column 70 may be filled out as well. The tax may be assessed by unit, by weight, by volume, etc. The example client data ends with four condition columns 72A-72D, where the answer is yes or no, or any other system representing true or false in response to the condition. For the plastic legislation example, conditions such as the following may be included: “Exists and is used only as packaging to transport into the UK?” “Is a road, rail, or ship container?” “Stores within the meaning of CEMA 1979?” and “Used for the immediate packaging of licensed human medicine?” A “YES” answer to any of these example conditions may result in an exemption for the designated product. In other implementations, the conditions may result in a different tax rate rather than an exemption, a credit being applied, etc.

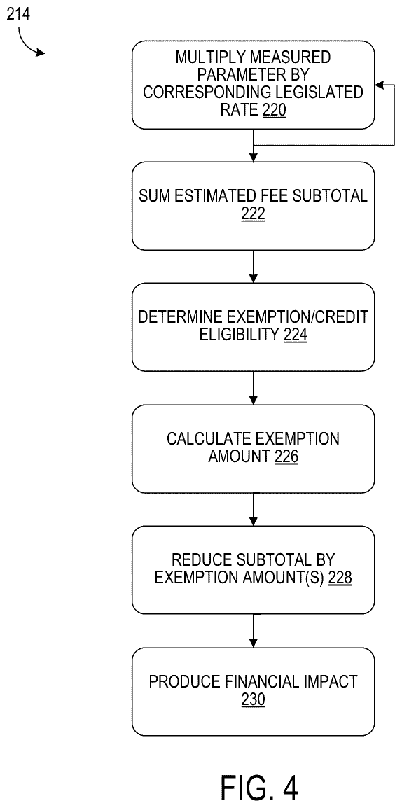

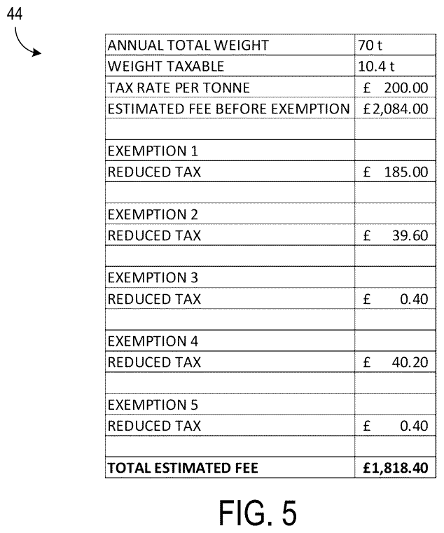

Turning to FIG. 4, detailed substeps of the “calculate financial impact” step 214 of the flowchart of FIG. 2 are illustrated, while FIG. 5 illustrates an example financial impact 44. Using the client data 54 explained above with reference to FIG. 3, the method 200 may further include, at 220, multiplying a measured parameter by a corresponding legislated rate, and repeating the step for any remaining parameters. The resulting amount is summed at 222 to subtotal an overall estimated fee for all products. In this example, the annual total weight of 70 (metric) tonnes is reduced to 10.4 tonnes by removing immediately ineligible products such as those not containing any plastic packaging. A tax rate of £200 per tonnes is applied. Therefore, the estimated fee before exemption is calculated by multiplying the tax rate by the taxable weight. If different products are assessed at different tax rates, then the multiplied values may be subtotaled here. Next, the method 200 may include, at 224, determining exemption or credit eligibility, which may be performed by checking the answers to the conditions explained above. Here, exemption amounts are calculated at 226 for each condition based on the legislation rules of the legislation model. Finally, the method 220 may include, at 228, reducing the subtotal by the exemption amounts, to produce the financial impact 44 at 230. Here, a total annual fee of £1,8183.40 is estimated for the user's organization. It will be appreciated that when the organization is subjected to multiple regulations of different legislation, then the server computing device 12 may be configured to calculate a financial impact for each legislation, and therefore the financial impact 44 represents an overall financial impact of the plurality of legislation on the organization, including the financial impact of each legislation.

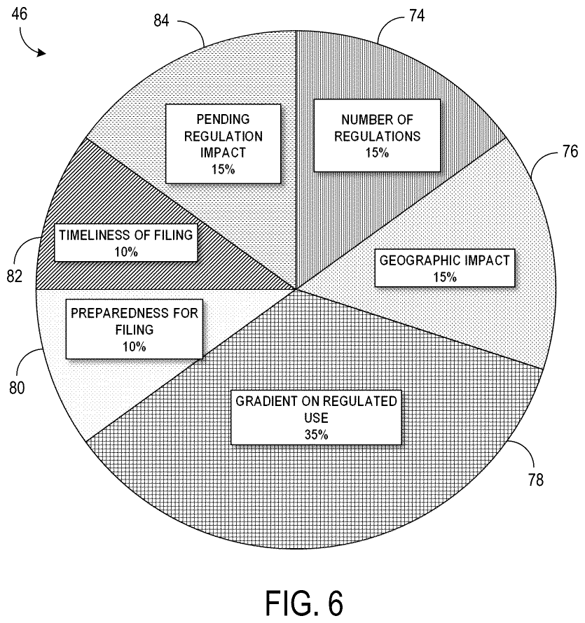

Turning to FIG. 6, as mentioned briefly above, the legislation model 44 may be used by the server computing device 12 or the client computing device 14 to create a sustainability impact metric 46 for the user of the client computing device 14. The sustainability impact metric 46 may indicate the impact that sustainability regulations and compliance have on the organization by distilling a complex set of features into a simplified metric, and may be used for past or current activities of the organization, or may be used to estimate future compliance. When estimating future compliance, the user has time to receive suggestions of ways to increase their compliance and therefore the organization's sustainability impact metric 46. The sustainability impact metric 46 may be a score in the form of, for example, a number (e.g., 1-10, 1-100%) or grade (A-F), etc. that indicates a better score versus a worse score.

The sustainability impact metric 46 may be generated in whole or in part by the financial modeling program 50, and may be broken down into several portions contributing to the overall score. The illustrated example is merely one example, and the sustainability impact metric 46 may vary depending on the organization's needs and goals. Furthermore, the percentages applied to each portion may be set appropriately, including setting any given portion to 0% and redistributing the percentage to other portions. In the depicted example, the sustainability impact metric 46 includes a number of regulations portion 74 indicating a number of regulations of the plurality of legislation to which the organization is subjected. Here, the number of regulations portion 74 makes up 15% of the overall sustainability impact metric 46. This portion may be calculated by analyzing the legislation with the context of an organization profile questionnaire as part of the client data 54. This profile acts as a filter to identify what regulations apply to the organization and the server computing device 12 will provide a count of the number that applies to complete this portion. The more regulations that apply to the organization, the higher the score will be.

The sustainability impact metric 46 may include a geographic impact portion 76 indicating a number of jurisdictions covered by the plurality of legislation in which the organization conducts business. Here, the geographic impact portion 76 makes up 15% of the overall sustainability impact metric 46. This portion may be calculated by analyzing where regulations apply with the context of the organization profile questionnaire. The profile acts as a filter to identify what regulations and what geographies or jurisdictions the company operates in. The more geographies that apply to the organization, the higher the score will be.

The sustainability impact metric 46 may include a gradient on regulated use portion 78 indicating a quantity of product or services of the organization subject to regulations of the plurality of legislation compared to the financial impact 44 of the plurality of legislation. Here, the gradient on regulated use portion 78 makes up 35% of the overall sustainability impact metric 46. For example, this portion may be calculated by analyzing the total amount of regulated product against the amount of product that is subject to taxes or fees, where a higher percentage results in a higher score. In the example detailed above regarding plastic packaging regulation, the gradient would be on the amount of plastic that is subject to fees/taxes divided by the total amount of plastic to generate a percentage. However, there would be a gradient score for each regulation that applies to the organization to help give an overall picture of regulatory impact on the organization.

The sustainability impact metric 46 may include a preparedness for filing portion 80 indicating a completion rate of compliance tasks regarding compliance of the organization with the plurality of legislation. Here, the preparedness for filing portion 80 makes up 10% of the overall sustainability impact metric 46. This portion may be calculated from a questionnaire that is based on a check list of compliance tasks for the region and regulation, generated by the sustainability planner 10. The more steps on the check list that are complete, the lower the score will be.

The sustainability impact metric 46 may include a timeliness of filing portion 82 indicating a timeliness of past filings by the organization required by the plurality of legislation. Here, the timeliness of filing portion 82 makes up 10% of the overall sustainability impact metric 46. This portion may be calculated by a questionnaire on whether the past quarter filings of the organization were completed on time or not. Failing to file on time is an indicator of issues in gathering the data and would therefore increase the score.

The sustainability impact metric 46 may include a pending regulation portion 84 indicating a number of regulations of a pending legislation that would apply to the organization if the pending legislation becomes law. Here, the pending regulation portion 84 makes up 15% of the overall sustainability impact metric 46. If no legislation is pending, this portion may be reduced to 0% and the portions 74, 76, and 78 may be increased by 5% each to compensate, for example. The pending regulation portion 84 may be calculated by analyzing where regulations apply with the context of the organization profile questionnaire. The organization profile may act as a filter to identify what regulations and what geographies the company is operating in. The more pending regulations that apply to the organization, the higher the score will be.

The above system and methods may be utilized to present the content and impact of new legislation in an easily digestible and actionable form to an organization using a sustainability planner. The sustainability planner can generate a financial impact of the legislation on the organization. Based on the financial impact and other factors, the sustainability planner may be configured to indicate to the user areas of potential improvement, such as underutilized exemptions or reductions or excessive use of a highly taxed category where alternatives exist. A sustainability impact metric, based in part on the financial impact, may indicate a total impact of sustainability regulation on the organization and provide a clear metric for the organization to plan activities regulated by new, and therefore typically less well understood, legislation.

In some embodiments, the methods and processes described herein may be tied to a computing system of one or more computing devices. In particular, such methods and processes may be implemented as a computer-application program or service, an application-programming interface (API), a library, and/or other computer-program product.

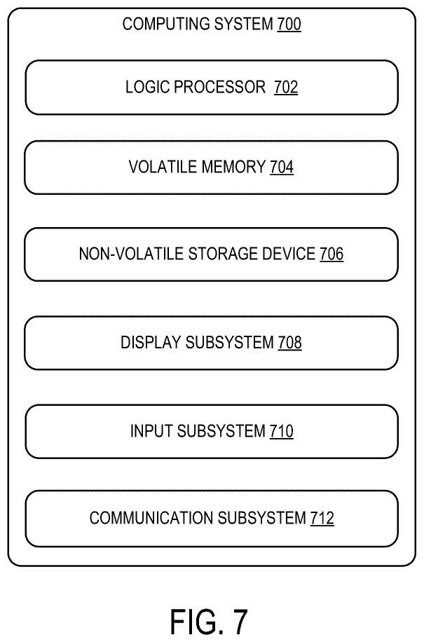

FIG. 7 schematically shows a non-limiting embodiment of a computing system 700 that can enact one or more of the methods and processes described above. Computing system 700 is shown in simplified form. Computing system 700 may embody the sustainability planner described above and illustrated in FIG. 1. Computing system 700 may take the form of one or more personal computers, server computers, tablet computers, home-entertainment computers, network computing devices, gaming devices, mobile computing devices, mobile communication devices (e.g., smartphone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 700 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A sustainability planner comprising:
a server computing device including one or more processors configured to execute instructions stored in associated memory to:
ingest legislation data to generate a legislation model including legislation rules of a legislation, using an AI modeling engine;
receive client data of an organization including parameters covered by the legislation;
apply the parameters of the client data to the legislation model to calculate a financial impact of the legislation on the organization;
calculate a sustainability impact metric indicating an overall impact of a plurality of legislation including the legislation and other legislation on the organization, based at least on the financial impact of the legislation; and
send the financial impact and the sustainability impact metric to a client device.

2. The sustainability planner of claim 1, wherein the sustainability impact metric includes a number of regulations portion indicating a number of regulations of the plurality of legislation to which the organization is subjected.

3. The sustainability planner of claim 1, wherein the sustainability impact metric includes a geographic impact portion indicating a number of jurisdictions covered by the plurality of legislation in which the organization conducts business.

4. The sustainability planner of claim 1, wherein
the server computing device is configured to calculate a financial impact of the plurality of legislation on the organization, including the financial impact of the legislation; and
the sustainability impact metric includes a gradient on regulated use portion indicating a quantity of product or services of the organization subject to regulations of the plurality of legislation compared to the financial impact of the plurality of legislation.

5. The sustainability planner of claim 1, wherein the sustainability impact metric includes a preparedness for filing portion indicating a completion rate of compliance tasks regarding compliance of the organization with the plurality of legislation.

6. The sustainability planner of claim 1, wherein the sustainability impact metric includes a timeliness of filing portion indicating a timeliness of past filings by the organization required by the plurality of legislation.

7. The sustainability planner of claim 1, wherein the sustainability impact metric includes a pending regulation portion indicating a number of regulations of a pending legislation that would apply to the organization if the pending legislation becomes law.

8. The sustainability planner of claim 1, wherein the server computing device is configured to automatically retrieve the legislation data from a publication of the legislation provided by a government entity enacting the legislation.

9. The sustainability planner of claim 1, wherein the legislation includes a regulation covering a product produced, sold, and/or used by the organization and the financial impact is a tax due relating to production, sale, or use of the product by the organization.

10. The sustainability planner of claim 9, wherein the legislation rules include calculations to determine estimated fees due and exemption or credit eligibility for the organization.

11. A method for sustainability planning, comprising:
ingesting legislation data to generate a legislation model including legislation rules of a legislation, using an AI modeling engine;
receiving client data of an organization including parameters covered by the legislation;
applying the parameters of the client data to the legislation model to calculate a financial impact of the legislation on the organization;
calculating a sustainability impact metric indicating an overall impact of a plurality of legislation including the legislation and other legislation on the organization, based at least on the financial impact of the legislation; and
sending the financial impact and the sustainability impact metric to a client device.

12. The sustainability planner of claim 11, wherein the sustainability impact metric includes a number of regulations portion indicating a number of regulations of the plurality of legislation to which the organization is subjected.

13. The sustainability planner of claim 11, wherein the sustainability impact metric includes a geographic impact portion indicating a number of jurisdictions covered by the plurality of legislation in which the organization conducts business.

14. The sustainability planner of claim 11, wherein
the server computing device is configured to calculate a financial impact of the plurality of legislation on the organization, including the financial impact of the legislation; and
the sustainability impact metric includes a gradient on regulated use portion indicating a quantity of product or services of the organization subject to regulations of the plurality of legislation compared to the financial impact of the plurality of legislation.

15. The sustainability planner of claim 11, wherein the sustainability impact metric includes a preparedness for filing portion indicating a completion rate of compliance tasks regarding compliance of the organization with the plurality of legislation.

16. The sustainability planner of claim 11, wherein the sustainability impact metric includes a timeliness of filing portion indicating a timeliness of past filings by the organization required by the plurality of legislation.

17. The sustainability planner of claim 11, wherein the sustainability impact metric includes a pending regulation portion indicating a number of regulations of a pending legislation that would apply to the organization if the pending legislation becomes law.

18. The sustainability planner of claim 11, wherein the server computing device is configured to automatically retrieve the legislation data from a publication of the legislation provided by a government entity enacting the legislation.

19. The sustainability planner of claim 11, wherein the legislation includes a regulation covering a product produced, sold, and/or used by the organization and the financial impact is a tax due relating to production, sale, or use of the product by the organization.

20. The sustainability planner of claim 19, wherein the legislation rules include calculations to determine estimated fees due and exemption or credit eligibility for the organization.
